(19) United States
(12) Patent Application Publication
(10) Pub. No.: US 2009/0142147 A1
(43) Pub. Date: Jun. 4, 2009

(54) MONITORING AND ADJUSTMENT SYSTEM AND METHOD FOR A HIGH PRESSURE FEEDER IN A CELLULOSE CHIP FEEDING SYSTEM FOR A CONTINUOUS DIGESTER

(75) Inventors: Scott Pope, Atlanta, GA (US); Richard O. Laakso, Queensbury, NY (US); Carl Luhrmann, Glens Falls, NY (US); Keith Vogel, Queensbury, NY (US)

Correspondence Address: NIXON & VANDERHYE, PC, 901 NORTH GLEBE ROAD, 11TH FLOOR, ARLINGTON, VA, 22203, US

(73) Assignee: ANDRITZ INC., Glens Falls, NY (US)

(21) Appl. No.: 12/257,625

(22) Filed: Oct. 24, 2008

Related U.S. Application Data
(60) Provisional application No. 60/984,699, filed on Nov. 1, 2007.

(51) Int. Cl. B65G 53/30; B65G 53/40; B65G 53/46

(52) U.S. Cl. 406/51; 406/63; 406/62; 406/52

(57) ABSTRACT

A method and computer controlled apparatus to control fluid leakage in a high pressure feeder and a stationary housing with a chamber in which rotates a pocket rotor. The method includes: monitoring the fluid leakage from the high pressure feeder, wherein the fluid leakage is discharged from a low pressure outlet of the high pressure feeder; determining whether the fluid leakage is within a predefined range of acceptable fluid leakage, and moving the pocket rotor in the chamber to adjust the fluid leakage.

### RELATED APPLICATION

This application claims the benefit of U.S. Provisional Patent Application Ser. No. 60/984,699 filed Nov. 1, 2007, the entirety of which is incorporated by reference.

### BACKGROUND OF THE INVENTION

This invention relates to a method and system for feeding comminuted cellulosic fibrous material (“chips”) to a treatment vessel, such as a continuous digester which produces cellulosic pulp. This invention particularly relates to monitoring and adjusting a high pressure feeder.

High pressure feeders (HPFs) transfer chips from a low pressure chip supply system to a high pressure system, such as a continuous digester system for chemical pulping of wood chips or other cellulosic material. HPFs are well-known and are described in, for example, U.S. Pat. No. 6,669,410. HPFs are a critical component of a continuous digester system in that they provide a high pressure slurry of wood chips and liquor to be fed to the digester vessel. Without the high pressure chip slurry provided by the HPF, the digester system is disabled. When a HPF is shut-down for repair or maintenance, the digesting process and the resultant production of pulp ceases until the HPF is restarted. There is a long felt need to prolong the operational periods of HPF and minimize the shut-downs of HPFs for maintenance.

High pressure feeders are conventionally mechanical rotary valve devices adjusted with manual controls. A common control adjustment is to manually adjust the clearance between a rotating pocket rotor and a cylindrical chamber of the housing for a HPF. The clearance is a gap between an outer cylindrical surface of the rotor and an inner cylindrical surface of the chamber. The clearance allows a small amount of liquid to serve as a lubricant between the pocket rotor and chamber. If the clearance is too wide, a pressure loss can occur in the high pressure fluid flow through the HPF, excessive liquid and fines may flow through the gap and accumulate in the housing, e.g., in end bells of the housing, and excessive liquid may leak through to a low pressure outlet of the HPF. If the clearance is too narrow, metal to metal contact may occur between the rotor and chamber and debris caught in the gap may etch grooves in the rotor or chamber. Accordingly, the clearance between the pocket rotor and chamber should be maintained in an acceptable range.

The clearance between the pocket rotor and chamber of the housing is adjusted by moving the rotor axially with respect to the housing. The pocket rotor and chamber each are slightly tapered. Because of the taper, the clearance between the rotor and housing can be adjusted by axial movement of the rotor. Conventionally, axial movement of the rotor was by means of a manual turning wheel at the end of a high pressure feeder.

Maintaining an optimal clearance between the pocket rotor and chamber is helpful to extend the operational life of the HPF, particularly the pocket rotor and surface of the chamber; avoid damage to the rotor and chamber; minimize the power load of the HPF, and minimize the fluid pressure loss due to fluid leakage through the clearance between the pocket rotor and the chamber of the housing. There is a long felt need for extending the operational period of high pressure feeders between maintenance or repair shut-downs of the HPFs. When a HPF is shut-down, the digesting operation may be temporarily interrupted for a period of, for example, eight (8) hours of no pulp production. Extending the operational period between maintenance and repair of HPFs can reduce the interruptions that occur in pulp production and allow for greater pulp production of the digester system.

### SUMMARY OF THE INVENTION

A method has been developed to control fluid leakage in a high pressure feeder and a stationary housing with a chamber in which rotates a pocket rotor, the method comprising: monitoring the fluid leakage from the high pressure feeder, wherein the fluid leakage is discharged from a low pressure outlet of the high pressure feeder; determining whether the fluid leakage is within a predefined range of acceptable fluid leakage, and moving the pocket rotor in the chamber to adjust the fluid leakage.

The fluid leakage may be determined as a difference between a flow through a high pressure outlet from the high pressure feeder and a sum of flows into the feeder. The pocket rotor may be coaxial with the chamber, and moving the pocket rotor includes moving the pocket rotor axially with respect to the chamber. The method may further comprise receiving vibration or acoustical signals from a vibration or acoustical sensor monitoring vibrations in or sounds emanating from the high pressure feeder, determining whether the vibration or acoustical signals indicate metal-to-metal contact between the pocket rotor and chamber, and if metal-to-metal contact is determined, moving the pocket rotor increase a gap between the pocket rotor and chamber.

A method has been developed to control a gap between a pocket rotor and a chamber of a high pressure feeder comprising: collecting data from at least one sensor monitoring at least one condition of the high pressure feeder; analyzing the collected data using a computer controller to generate a desired value of the gap, and adjusting an axial position of the pocket rotor in the chamber to achieve the desired value for the gap.

A method has been developed to control a rotational speed of a pocket rotor in a chamber of a high pressure feeder comprising: rotating the pocket rotor; determining an actual flow rate of a high pressure slurry discharged by the high pressure feeder, wherein the high pressure slurry passes through the rotating pocket rotor; comparing the determined actual flow rate to a desired flow rate of the high pressure slurry discharged by the high pressure feeder; adjusting a rotational speed of the rotating pocket rotor until the comparison of the determined actual flow rate and the desired flow rate are within a predefined range.

A high pressure feeder for a slurry has been developed comprising: a housing having a low pressure inlet for the slurry, a high pressure outlet for the slurry, a low pressure outlet for low pressure fluid removed from the slurry in the feeder, a high pressure fluid inlet, and a chamber in fluid communication with each of the inlets and outlets; a pocketed rotor rotatably positioned in the chamber, wherein said pocketed rotor is movable in the chamber and the movement determines a gap between the pocketed rotor and the chamber; an actuator moving the pocketed rotor to adjust the gap, and a computer controller generating commands to the actuator to determine an adjustment to the gap, wherein the controller includes a control algorithm which generates the commands based on an input sensor of an operating condition of the high pressure feeder.

In the high pressure feeder, the pocketed rotor may be a tapered cylindrical rotor and is movable axially in the chamber which includes a tapered cylindrical surface facing the rotor, and the actuator includes a shaft coaxial with the pocketed rotor and the shaft is moved axially based on the generated commands. The actuator may further comprise a gear motor which axially moves the shaft and said gear motor is actuated based on the generated commands. In addition, a remote computer may be coupled via the internet to the computer controller, wherein the remote computer communicates information regarding a desired gap to the computer controller which applies the desired gap information to generated the commands. The input sensor may include at least one of a vibration sensor monitoring a vibration of the feeder, an acoustical sensor monitoring sounds emanating from the feeder, a fluid pressure sensor monitoring a fluid pressure in the gap, a power meter monitoring power applied to rotate the pocket rotor, and flow meters measuring a high pressure slurry flow from the high pressure outlet, a high pressure liquid flow into the high pressure inlet, and a low pressure slurry flow into the low pressure inlet.

### BRIEF DESCRIPTION OF THE DRAWINGS

FIG. 1 is a schematic diagram of a conventional chip feed system for feeding a slurry of comminuted cellulosic fibrous material to a continuous digester or other high pressure vessel.

FIG. 2 is a perspective view a high pressure feeder having a remotely controllable rotor clearance adjustment mechanism and shows a cut-away view of the interior of the housing for the feeder and a pocket rotor in the housing.

FIG. 3 is an exploded view of a conventional pocket rotor, cylindrical chamber of the feeder housing and a screen plate.

FIG. 4 is side view of a housing for the rotor clearance adjustment mechanism with a portion of the housing cut away to show the axial movement of the control shaft for the mechanism.

FIG. 5 is an end view of the housing for the rotor clearance adjustment mechanism.

### DETAILED DESCRIPTION OF THE INVENTION

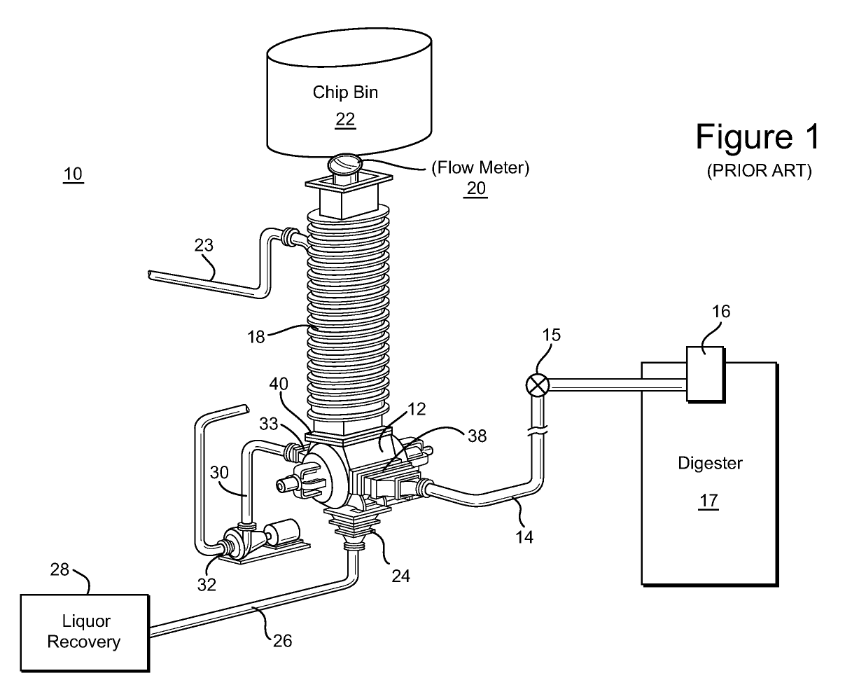

FIG. 1 is a schematic diagram of a conventional feed system 10 for providing a slurry of comminuted cellulosic material, e.g., wood chips, to a high pressure feeder (HPF) 12 and to a high pressure output conduit 14 leading to an inlet, e.g., a top separator 16, of a continuous digesting vessel 17. The HPF receives a low-pressure slurry or lo-level feed, via a chip chute 18, of comminuted cellulosic fibrous material (“chip slurry”) and outputs a high-pressure chip slurry. The high pressure slurry is suitable for introduction into a continuous digester, chip steaming vessel and other high pressure chip processing systems. A flow meter 15 may measure the rate of slurry flow through the output conduit 14 and to the inlet 16 of the digester 17.

The low pressure slurry is fed to the chip chute 18 through a chip flow meter 20 from a chip bin 22 or other chip supply system, such as shown in U.S. Pat. No. 5,622,598. Additional liquor may be added to the chip flow in the chip chute 18 through conduit 23.

The HPF has a low pressure outlet 24 for liquor which flows through the HPF but does not exit to the high pressure stream in conduit 14. The liquor from the low pressure outlet 24 flows through conduit 26 to a liquor recovery system 28 that may circulate the liquor to, for example, the low pressure side of the chip feed system. Liquor is pressurized by pump 32 and flows at high pressure through conduit 30 to the high pressure inlet 33 of the HPF. The high pressure liquor in the HPF pressurizes the chip slurry from the chip chute such that the chip slurry exits the HPF at high pressure into conduit 14.

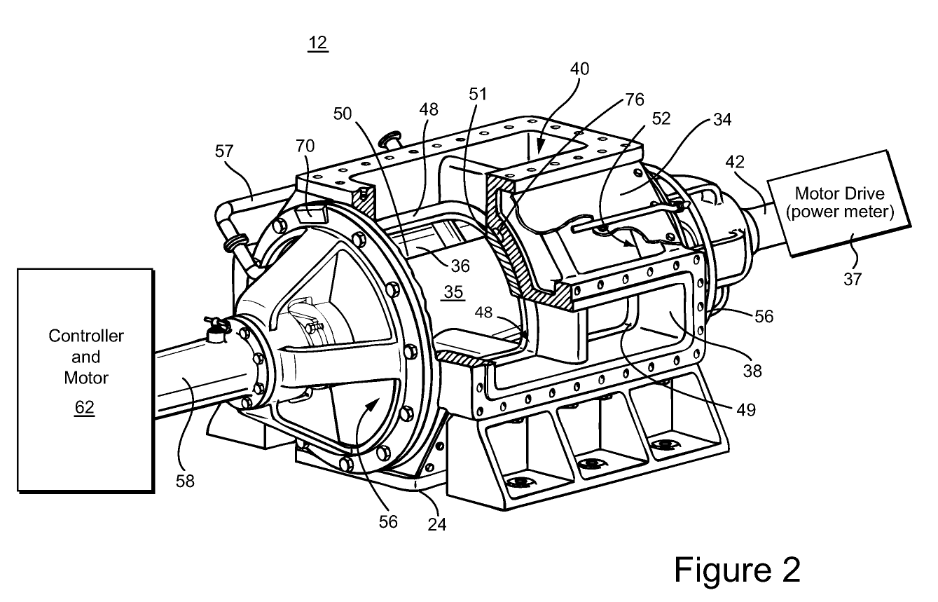

FIG. 2 shows a high pressure feeder 12 comprising a stationary housing 34 with a pocketed cylindrical rotor 35 mounted for rotation in a tapered cylindrical chamber 48 of the housing. The housing includes four ports: a high-pressure inlet port 33 (in rear of housing and show in FIG. 1); a high-pressure outlet port 38; a low-pressure inlet port 40 and a low-pressure outlet port 24 (in bottom of housing and shown in FIG. 1). The low-pressure inlet port 40 is opposite on the housing 34 the low-pressure outlet port 24. The high-pressure inlet port 33 is opposite on the housing the high-pressure outlet port 38.

The pocket rotor 35 is driven by a variable speed motor and gear reducer 37 coupled to a drive shaft 42. The pocket rotor is driven to rotate in the housing chamber 48, such that the through-going pockets 36 of the rotor sequentially communicate with the four ports of the housing.

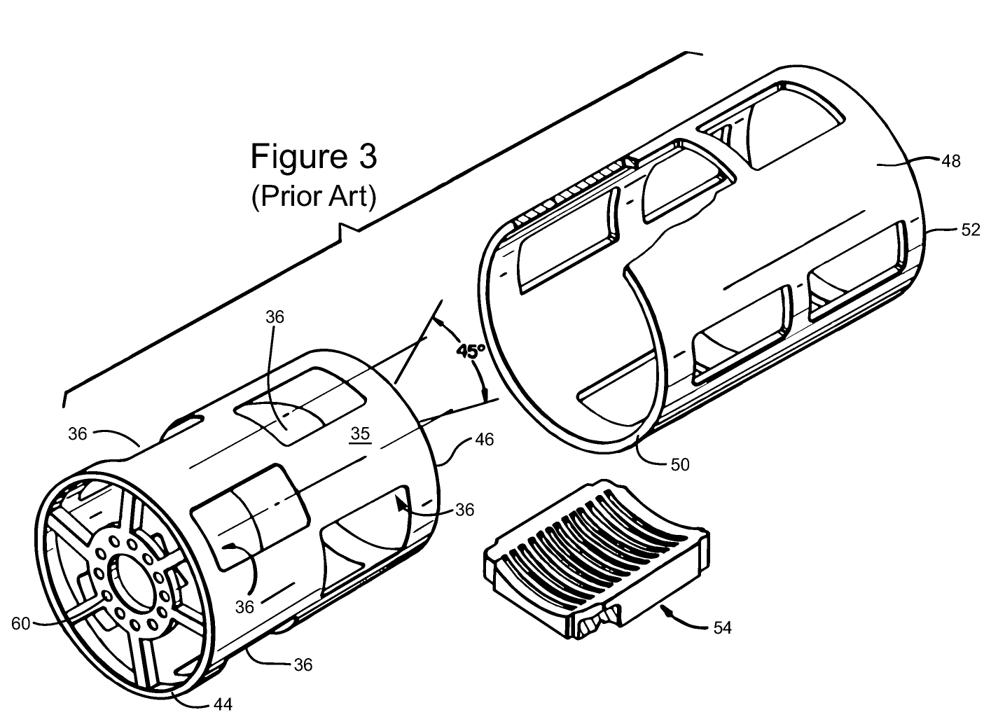

As shown in FIG. 3, the pocket rotor 35 contains two or more through-going pockets 36 such that different pockets communicate with different high and low-pressure ports as the rotor rotates. Each pocket in the rotor defines a passage through the rotor with openings on opposite sides of the passage. The rotor typically rotates at a speed of between about 5 to 15 revolutions per minute (rpm), preferably, between about 7 to 10 rpm, depending upon the capacity of the HPF and the production rate of the pulping system it is used to feed.

The low-pressure outlet port of the HPF is typically provided with a screen element 54, for example, a cast horizontal bar type screen element such as the screen element 29 in U.S. Pat. No. 5,443,162. The screen element retains the chips in the slurry within the feeder and allows some of the liquid in the slurry to pass out of the second end of the pocket, through the screen and out through the low pressure outlet port.

(if we go into too much detail about the grid do we give up protection on Metso compact feed systems where the HPF has no grid? Answer: It is OK to give detail in the description portion of the patent application. The detail will not limit the scope of the claims of the application. The claims (at the end of the application) define the scope of the patent. The claims are not limited to a screen and seem not to exclude the Metso compact feed system.)

Chips flow into a pocket(s) 36 of the rotor 35 when the openings of the pocket align with the low pressure inlet 40 and low pressure outlet 24 of the HPF, e.g., the pocket is vertical. The chips flow into the pocket from the chip chute 18 and mix with any remaining chips retained in the pocket by the screen element 54. The screen element prevents chips flowing through the pocket and out the low pressure outlet 24. As the pocket rotates 90 degrees, e.g., a quarter turn, the chips in the pocket are transported from a low pressure flow to a high pressure flow as the openings in the pocket align with the high pressure inlet 33 and high pressure outlet 38 of the HPF. After this one-quarter revolution of the rotor, the first end of the pocket that was once in communication with the low-pressure inlet 40 is placed in communication with the high pressure outlet 38. The high-pressure outlet typically communicates with the inlet of a digester, either a continuous or batch digester, via one or more conduits. At the same time, this quarter-turn rotation of the rotor also places the second end of the through-going pocket, which was just in communication with the low-pressure outlet, in communication with the high-pressure inlet 33. The high pressure inlet typically receives a flow of high-pressure liquid from a high-pressure hydraulic pump 32. The pressure of this liquid typically ranges from about 5 to 15 bar gauge, and is typically about 7 to 10 bar gauge. This high-pressure liquid displaces the slurry of chips and liquid from the through-going pocket and out of the high-pressure outlet and ultimately to the inlet of the digester.

As the pocket rotor continues to rotate, the second end of the pocket which received the high-pressure fluid is placed in communication with the low-pressure inlet and receives another supply of slurry from the conduit connected to the low-pressure inlet. Similarly, the first end of the pocket is rotated into communication with the low-pressure outlet of the housing, having the screen element. The process described above repeats such that during one complete revolution of the rotor each through-going pocket receives and discharges two charges of chips and liquid. The rotor typically contains at least two, typically four, through-going pockets such that the rotor is repeatedly receiving slurry from the low-pressure inlet and discharging slurry out the high-pressure outlet. The ends of the these pockets act as both an inlet for slurry and an outlet depending upon the orientation of the rotor.

FIG. 3 shows the pocket rotor 35 having a cylindrical shape with a slight taper extending from one end 44 of the rotor to the opposite end 46 of the rotor. The first end 44 of the rotor may a smaller diameter than the opposite end of the rotor. The rotor 35 fits in a tapered cylindrical chamber 48 (FIG. 2) fixed to the housing. The chamber has a taper similar to the taper of the rotor. A first end 50 of the chamber has a smaller diameter than an opposite end 52 of the chamber. The chamber has openings 49 that are aligned with the inlets and outlets of the housing of the HPF. The chip slurry flows through openings 49 in the chamber to enter the pockets 36 of the rotor and exit the pocket through openings in the chamber to the high pressure outlet of the HPF. Similar, high pressure liquid pass through the openings 49 in the chamber to enter the pockets of the rotor and discharge through openings in the chamber to exit through the low pressure discharge of the HPF.

A small tapered annular gap 51 is formed between the rotor and the chamber, when the rotor is inserted into the chamber. The gap 51 allows the rotor to rotate within the chamber. The width of the gap is determined by the axial position of the pocket rotor 35 with respect to the chamber 48. Due to the complementary conical shapes of the rotor pocket and chamber, the gap may be narrowed by moving the pocket rotor axially towards the small diameter end of the chamber. Similarly, the gap 51 may be expanded by moving the rotor pocket axially towards the large diameter end of the chamber. During its axial movement, the rotor remains within the chamber.

The width of the gap 51 may be changed by automatically or manually adjusting the axial position of the rotor pocket. In contrast to the conventional practice of manually adjusting the axial position of the rotor pocket in the chamber, the high pressure feeder disclosed herein includes a motor driven shaft 58 that is coupled to an end of the pocket rotor. The shaft 58 is axially aligned with the pocket rotor. A controller assembly 68 adjusts the axial position of the shaft and, thus, the axial position of the pocket rotor in the chamber of the housing.

A small amount of liquid flows through the gap 51, such as from outlets in the pocket rotor 35. The liquid serves as a lubricant between the rotor 35 and cylindrical chamber 48. The liquid drains through the screen 54 below the chamber and adjacent the low pressure outlet of the housing. The liquid from the low pressure outlet may be reused in, for example, the feed system 10.

In addition, liquid may collect in end bell chambers 56 of the housing that are adjacent opposite ends of the pocket rotor 35 and chamber 48. The liquid in the bell chambers 56 is preferably maintained under pressure to prevent additional flow, which may include fines, into the bell chambers. A conduit 57 for additional white liquor is connected to an inlet port to each of the bell chambers 56 at opposite ends of the housing for the HPF. The white liquor is provided under pressure from the conduit 57 to pressurize the liquid in the bell chambers and to prevent a flow of liquor and fines from the pocket rotor into the bell chambers.

If the gap 51 is too large, excessive liquids and small particles, such as fiber fines, sand and other small debris, especially metal, rock and sand, in the gap may cause grooves to form in the outer surface of the pocket rotor 35 and the inner surface of the chamber 48. If the gap 51 between the pocket rotor 35 and the cylindrical chamber 48 is too large, excess liquid, fines and other small debris may enter the gap through openings in the pocket rotor. The fines and debris may flow through the gap and collect in interior bell chambers 56 and adjacent the axial ends of the rotor pocket. If excessive fines and debris collect in the bell chambers, the fines may resist the rotation of the rotor, cause the rotor components to wear and increase the power consumption of the high pressure feeder.

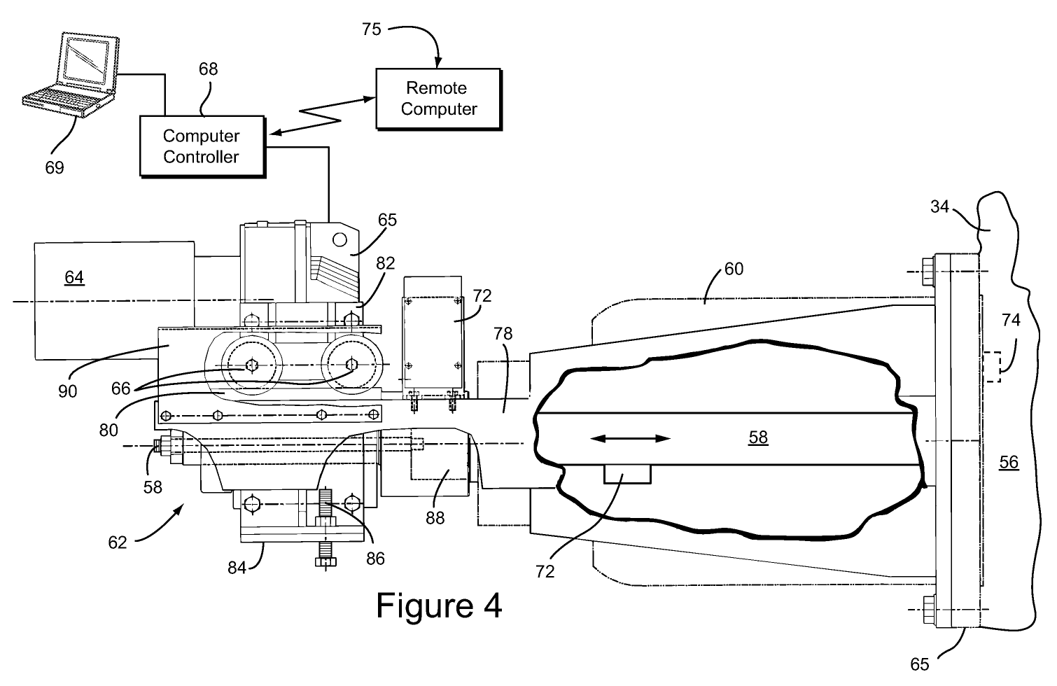

FIG. 4 shows a controller assembly 62 for a controller 68, gear motor 64, gear box 65, and a shaft 58 that is coupled to and adjusts the axial position of the pocket rotor. The shaft 58 is contained within housing 60. The controller housing has an end 65 that couples to an end bell housing 56 of the HPF. The controller assembly 62 supports an actuator for axially moving the shaft 58 and pocket rotor. The actuator includes a gear motor 64 and gearbox 65 that controls the axial position (indicated by the arrows) of the shaft 58 and hence the axial position of the pocket rotor. The gearbox engages spiral threads on the shaft 58 to rotate the shaft. The rotation of the shaft by the gearbox causes axial movement of the shaft and pocket rotor. The gear motor 64 receives commands from the computer controller 68 to turn the gearbox 65 by a prescribed angular amount. By commanding the gear motor and gear box, the computer controller adjusts the axial position of the shaft and pocket rotor. The gear motor 64 tracks the rotation of the shaft by the gearbox and provides signals of the rotation that enable the computer controller to determine the axial position of the shaft. In addition, the axial position of the shaft is monitored or measured by a position sensor, such as by a laser position sensor 72.

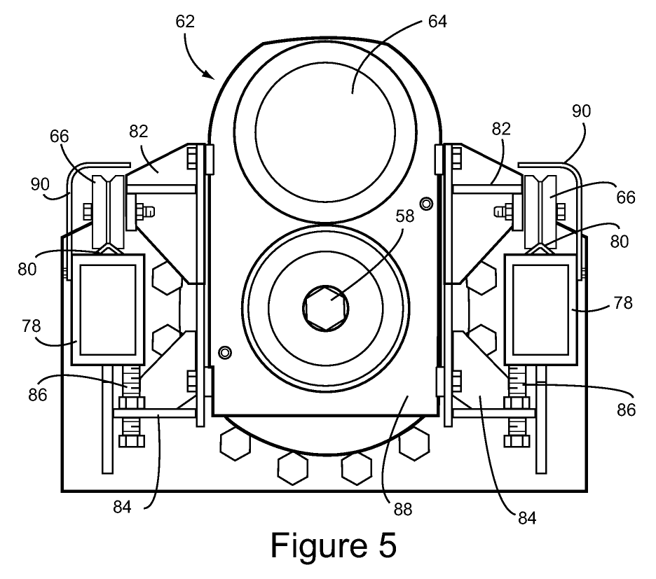

FIG. 5 shows an end view of the controller assembly 62 and HPF. The controller assembly is attached to the HPF by a pair of brackets 78 that form cantilevered beams attached at one end to the housing of the HPF and support a track 80 for the rollers 66 of the controller assembly 62. The beams of the brackets may be hollow rectangular beams that extend horizontally. The controller assembly 62 may fit between the brackets. The roller wheels 66 of the controller assembly 62 rest on the tracks 80 and enable the controller assembly 62 to move laterally along the tracks as the shaft 58 moves laterally with respect to the HPF. A pair of roller wheels 66 on each side of the controller assembly are mounted on a frame 82 that is fixed to the controller assembly. The roller wheels may include an annular groove that rides on a ridge of the track 80. A lower frame 84 is also fixed to each side of the controller. The lower frame 84 includes a bolt 86, pin or other positioning device prevents the roller wheels 66 from jumping upward and unintentionally coming off the track. The bolt 86 may be retracted to allow the controller assembly 62 to be installed on or removed from the HPF. A generally horizontal frame 88 supports the gear motor 64, gear box 65 and other components of the controller assembly. The horizontal frame is arranged between the brackets 78. A protective guard 90 may cover the rollers 66 and the tracks 80.

The computer controller 68 receives input signals indicative of the operating condition of the HPF and chip feed system. The input signals may be generated by sensors that may include vibration or acoustical sensors 70 (FIG. 2), e.g., three to four, mounted on the housing of the HPF; a chip flow meter 20 measuring the chip flow from the low pressure side of the chip feed system; a flow meter 15 measuring the high pressure flow through conduit 14 leading to the digester; a power meter in the motor drive 37 for the HPF (where the meter measures the electrical load of the HPF); pressure sensors 74 in the interior of the HPF such as in the bell chambers 56; a sensor 72 measuring the rotation and position of the drive shaft 58, and a sensor 76 measuring a fluid pressure in the gap 51. The computer controller 68 monitors the output signals from the sensors, meters and other devices monitoring various operating conditions of the HPF and chip feed system. Based on the output signals, the computer controller 68 may determine an appropriate clearance gap 51 between the pocket rotor and the chamber in the HPF. The controller uses the appropriate gap clearance to determine a desired axial position of the shaft 58.

The computer controller 68 may include a display and user input device 69 that presents information to a human operator regarding the current operating condition of the HPF, and prompts for suggested changes to the axial position of the pocket rotor. For example, the displayed prompt may indicate that the pocket rotor should be advanced inward or outward a suggested distance, e.g., 2 mm, or one predetermined step.

The computer controller 68 may have a manual mode in which no automatic adjustments are made by the controller to the axial position of the pocket rotor. In manual mode, the controller may only display suggested actions by generating prompts to be presented on the display and for the benefit of human operators reading the display. The manual mode may allow an operator to enter commands in the user interface device 69 to cause the drive gears to advance or retract the shaft and pocket rotor by a distance specified by the operator. The commands may include, for example, commands to advance the pocket rotor by one millimeter or position pocket rotor at a specified axial position.

The computer controller 68 may have an automatic mode that includes the features of the manual mode and an additional feature that allows the human operator to authorize the controller 68 to automatically execute certain operations, such as a “flush operation” during which the position the axial position of the pocket rotor is moved slightly in and out in a cyclical operation to flush fines out of the end bell of the HPF housing. Fines are small fibrous particles from wood chips. In automatic mode, the display 69 prompts the operator to authorize the flush operation when the controller detects that an excessive amount of fines may be in the end bells.

The computer controller 68 may have a remote mode in which it automatically adjusts the axial position of the shaft and pocket rotor based on analysis performed by the controller of sensor signal inputs regarding the condition of the HPF. In remote mode (but equally applicable to automatic and manual modes), the controller 68 may report the operation condition of the HPF to a remote computer 75 via the internet. In remote mode, the axial position of the pocket rotor may be adjusted based on commands entered by an operator at the remote computer 75.

In at least the remote mode, the computer controller 68 automatically turns the gears of the gear box 65 to move the shaft and pocket rotor and thereby adjust the clearance gap 51. The controller 68 may adjust the clearance based on the sensor signals that provide data regarding the operation of the HPF and algorithms stored in electronic memory of the controller. The algorithms convert the input signals from the sensors and commands from the operator into command signals for the gear motor 64 and gear box 65.

For example, the clearance gap 51 is preferably maintained such that the pressure of the liquor in the gap is below the pressure level of the white liquor injected into the end bell chambers 56 by the conduits 57. Maintaining the pressure in the gap to be below the pressure in the bell chambers assists in preventing fines from flowing into the bell chambers. In addition, the gap is preferably maintained to minimize wear between the rotor and cylindrical chamber 48 of the housing. Monitoring the vibration in or sounds emanating from the HPF provides an indication of whether metal-to-metal contact is occurring between the pocket rotor and chamber. The signals from the vibration or acoustical sensors provide data used by the controller to determine if the clearance gap should be adjusted. Further, the gap should preferably be varied periodically by shifting the pocket rotor axially with respect to the cylindrical chamber to avoid forming a groove in the housing or pocket rotor due to metal, sand or other hard debris caught in the gap.

If the clearance of gap 51 remains constant, the rate of leakage of liquid through the gap should be substantially constant. A change in the rate of leakage while the gap 51 is constant, suggests that the gap should be adjusted. An approach to determining when the gap should be adjusted is to monitor the leakage of liquor through the low pressure outlet of the HPF and reduce the clearance if the leakage becomes excessive. The leakage may be determined as the rate of flow through the high pressure conduit (as measured by flow meter 15) minus the input flows to the HPF including the chip flow as measured by flow meter 20, liquid flow, e.g., cold blow flow, through conduit 23, and the high pressure liquid entering the HPF feeder through input 33). The ratio of the leakage to the makeup liquor flow through conduit 57 to the HPF housing minus the ratio of make-up liquor to the flow of chips from the chip supply. An increase in the ratio of makeup liquor to chip flow indicates the amount of leakage through the gap is increasing.

The computer controller 68 may perform various analysis of the condition of the HPF and, specifically, the gap between the pocket rotor 35 and the cylindrical chamber 48 of the HPF housing. A first exemplary analysis is to monitor the electrical load placed by the HPF on the drive motor 37. This electrical load is measured by a power meter and reported to the computer controller 68. The electrical load is indicative of the width of the gap between the pocket rotor and the cylindrical chamber. A relatively low electrical load indicates that the gap is wide because relatively little friction is induced by the cylindrical chamber on the rotating rotor. A narrow gap increases the friction induced by the cylindrical chamber on the rotor and thus increases the electrical load of the HPF on the motor.

The computer controller 68 may store a predetermined maximum electrical load level and a predetermined preferred range of electrical loads, which may be a range of 95% to 85% of the maximum electrical load level. By comparing the actual electrical load to the predetermined maximum electrical load level and a preferred range of electrical loads, the controller may issue prompts on the display of suggested adjustments to be made to the axial position of the pocket rotor and displays warnings that, for example, the current electrical load level exceeds the maximum load level. Further, the controller may automatically retract the pocket rotor by a predetermined distance, e.g., 0.5 to 3 mm. If the actual electrical load exceeds the maximum load level for a predetermined period of time, the controller may command an automatic retraction of the pocket rotor. The controller may issue a warning on the display if the actual electrical load is outside of the preferred range of electrical loads.

A build up of fines in the bell chambers 56 tends to increase the rotational friction between the pocket rotor and chamber and thereby increases the power load on the motor driving the HPF. The build up of fines in the bell chambers will press fines against the ends of the pocket rotor. The movement of the rotating ends of the rotor against the fines in the bell ends results in friction that acts against the rotation of the pocket rotor. The data output signals from the sensors monitoring the motor power load typically detect an increase in the motor power load when the fines build up in the end bells. An increase in the power load while the gap clearance is held constant suggests that friction in the HPF is increasing and an assumption may be made that the friction increase is due to a build of fines in the bell ends 56.

It is preferable to confirm the presence of fines in the end bell because an increase in the motor power load of an HPF may be caused by conditions other than the presence of fines in the end bells. For example, the motor power load may increase due to the gap clearance being too small such that the pocket rotor is too close to the cylindrical chamber of the housing.

The sensors may be monitored by the controller 68 to confirm that the increase in motor power load corresponds to an unacceptable build up of fines in the end bell. For example, a vibration or acoustical sensor 70 attached to one or both of the end bells may sense a vibration or acoustic signal indicative of fines build up in the end bell. In addition, the vibration or acoustical sensors may generate output signals indicating that metal-to-metal contact is occurring in the gap or that debris is caught in the gap. The controller 68 may interpret these signals indicative of metal-to-metal contact or debris in the gap as indicating that the gap is too narrow and generate a prompt or command to retract the pocket rotor by for example, 0.5 mm to 2 mm, increase the gap between the rotor and chamber. Further, a sensor, e.g., a light source and photo-detector sensor to detect reflections by fines, may be internal to the end bells to monitor the composition of the liquid in the end bell and, particularly, detect fines in the liquid.

Another potential approach to determining whether a power load increase is due to fines build up is to monitor the rate of increase in the power load. A slow increase rate may indicate that fines are building up in the end bells. A rapid rate of increase may indicate that the clearance gap is too narrow and/or that debris has become lodged in the gap.

To purge a build up of fines in the bell ends, the pocketed rotor is moved axially inward and outward in small incremental steps to agitate the fines in the ends and flush out the fines as liquor in the ends flows out through the gap and into the pocket rotor. The agitated fines flow with the liquor through the gap, into the pocket rotor and out the high pressure outlet of the HPF.

To purge fines, the controller for the motor drive advances the pocket rotor axially further into the cylindrical chamber 48, such by a small step of, for example, 0.25 to 4 millimeters (mm) and preferably 0.5 mm to 1 mm. An encoder 72, e.g. a laser position measurement instrument, measures the axial movement of the shaft and hence the axial movement of the rotor pocket with respect to the cylindrical chamber. Signals from the encoder to the controller 68 allow the controller to accurately determine the axial position of the pocket rotor with respect to the cylindrical chamber.

The controller may monitor the rotational speed of the HPF feeder and control the HPF speed or issue prompts as to suggested HPF speeds. For example, the controller may determine the HPF speed based on the chip flow meter 20, such that the flow rate determined by the flow meter is proportional to the HPF speed. Further, the HPF speed may be based on an average of the chip flow rate as determined by flow meter 20 over a period of time, such as 10 minutes to two hours. If the controller automatically adjusts the speed of the HPF, the controller may make adjustments in small speed steps, e.g., less than 5% of the rotational speed of the HPF. After each speed step adjustment, the controller waits for the chip level in the chip chute 18 to maintain a steady state and thereafter determines if the HPF speed is within a predetermined range, e.g., a standard deviation, of the prescribed proportion of the chip flow rate. Another speed step adjustment may be made if the HPF speed is outside of the predetermined range.

The “Plug Position” is the axial position of the pocketed rotor. The shaft encoder sensor 72 provides an indication of the axial position of the pocketed rotor. Other signal indicators of the plug position include whether the gear motor is one or off, and the HPF rotor drive motor load as measured by power sensor 37. The positioner motor receives commands from the computer controller 68 that indicate the rotation to be applied to turn the gears and hence axially move the shaft 56 and the pocket rotor. For example, the computer controller 68 may command the positioned motor to turn the gears in the gear box 65 clock-wise and counter-clockwise a certain rotational amount over a predefined period to move the pocket rotor in and out axially to flush fines from the bell chamber.

Manual mode: The operator moves the axial position of the pocket rotor by inputting commands to the user interface 69 or by a remote computer 75. If the operator moves the pocket rotor in too far in an axial direction and the controller detects that the power load exceeds a predefined maximum load, the controller automatically overrides the human operator and retracts the pocket rotor to increase the gap 51. In this situation, the controller issues an alarm and informs the operator that the maximum motor power load had been exceeded.

Reciprocating Movement of Pocket Rotor: If the computer controller detects a power load increases and determines that the vibration or acoustic sensors do not indicate metal on metal contact between the rotor and casing, the controller determines that a potential fines build up has occurred in the bell chambers. The controller may automatically act to move the pocket rotor in and out axially or issue an advisory notice to the operator to recommend such in and out movement to flush the fines from the bell chamber.

Storage of Pocket Rotor Axial Position. The computer controller stores data regarding the operational history of the HPF, including data indicating historical axial positions of the rotor pocket and whether the axial positions had associated excessive liquid leakage or metal-to-metal contact. Prior acceptable rotor pocket axial positions may be used to reset the rotor pocket after HPF maintenance procedures or other operations in which the rotor pocket is retracted partially from the chamber. Preferably, the rotor pocket is advanced axially to the last known acceptable axial position in the chamber. If further axial movements of the pocket rotor are made, such further movements may be at a slower axial speed than the speed at which the rotor was advanced to its last known acceptable position.

Auto Mode: The controller automatically determines a desired axial rotor position. The desired axial rotor position may be determined to achieve a optimal amount of fluid leakage through the low pressure outlet of the HPF. In auto mode, the controller may periodically move the pocketed rotor in and out (axial reciprocal movement) to flush fines from the bell end chambers. The positioner motor may relatively rapidly turn the gears box 65 to move the reciprocally to flush the fines and then returns the pocket rotor to the last known acceptable axial position. After the pocket rotor has returned to its last known acceptable position, the positioner motor may more slowly turn the gears as the controller determines the axial position of the pocket rotor that provides the best leakage flow from the HPF or the controller applies some other criteria to optimize the HPF.

Flush Indications: The leakage flow exceeds a predefined flow limit, and the power load sensor detects a high or increasing power being applied to rotate the pocket rotor.

A flush should preferably move the pocket rotor reciprocally axially about 2 mm, as an example. After two or three reciprocal cycles the pocket rotor may be moved to its last acceptable axial position. The controller thereafter determines if the power load has been reduced which indicates that the fines were successfully flushed from the bell chambers. In addition, flush schedules may be performed pursuant to a schedule, such as every 10 hours. The controller stores data indicating when flush operations occurred.

During a flush operation, the controller may apply a relatively high pressure purge flow to the conduit 57 to provide high pressure liquor to the end bell chambers 56. This purge flow may only be used for the fines flush operation and assists in flushing fines from the bell chambers and maintain adequate pressure and liquor flow at and through the end bell chambers. This flow will have a high flow limit except for the fines flush procedure.

Pocket Position Adjustment: The controller may applied a position adjustment that measures the amount of liquor leakage from the HPF and, based on this measurement, determines whether to adjust the axial position of the pocket rotor. For example, when leakage exceeds a predetermined rate, the controller may advance the pocket rotor into the chamber until the power load increases to a predetermined limit. Thereafter, the controller may retract the pocket rotor by a prescribed distance, such as 2 mm.

Leakage Test: If Leakage is greater than a predefined value, the controller may perform a leakage adjustment operation. During this operation, the controller calculates leakage as the amount of make-up liquor flow added to the low pressure chip feed minus the white liquor added initially to the chips from which sum is subtracted the cold blow to feed (CbtoFeed) (DEFINE THIS). Alternatively, the leakage may be determined based on a Leakage RPM (revolutions per minute) which is the makeup liquor flow RPM divided by the chip meter RPM. An exemplary equation defining leakage is:

HPF LeakageRPM/ChipmeterRPM=MakeupLiquorFlowMeterRPM/chipmeterRPM.

Baseline Data: When the HPF is started, the controller may apply baseline data as acceptable liquor leakage values and as power loads indicating fines buildup. Baseline Data: Current Life expectancy Weekly runin (slope) % Ace Uptime (hpf control is off) After the HPF has operated and data has been acquired regarding its operation, the controller may thereafter use historical data collected from HPF operation to provide better leakage values and power load values indicating a fine buildup.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method to control fluid leakage in a high pressure feeder and a stationary housing with a chamber in which rotates a pocket rotor, the method comprising:
monitoring the fluid leakage from the high pressure feeder, wherein the fluid leakage is discharged from a low pressure outlet of the high pressure feeder;
determining whether the fluid leakage is within a predefined range of acceptable fluid leakage, and
moving the pocket rotor in the chamber to adjust the fluid leakage.

2. The method of claim 1 wherein the fluid leakage is determined as a difference between a flow through a high pressure outlet from the high pressure feeder and a sum of flows into the feeder.

3. The method of claim 1 wherein the pocket rotor is coaxial with the chamber, and moving the pocket rotor includes moving the pocket rotor axially with respect to the chamber.

4. The method of claim 1 further comprising:
receiving signals from at least one of a vibration sensor and an acoustical sensor monitoring vibrations in or sounds emanating from the high pressure feeder,
determining whether the signals indicate metal-to-metal contact between the pocket rotor and chamber, and
if metal-to-metal contact is determined, moving the pocket rotor increase a gap between the pocket rotor and chamber.

5. A method to control a gap between a pocket rotor and a chamber of a high pressure feeder comprising:
collecting data from at least one sensor monitoring at least one condition of the high pressure feeder;
analyzing the collected data using a computer controller to generate a desired value of the gap, and
adjusting an axial position of the pocket rotor in the chamber to achieve the desired value for the gap.

6. The method of claim 5 further comprising monitoring the actual axial position of the pocket rotor and determining whether the actual axial position corresponds to the desired value for the gap.

7. The method of claim 5 wherein the collected data represents power applied to rotate the pocketed rotor, analyzing the collected data includes detecting an increase in the power applied to rotor that pocketed rotor exceeding a predefined power limit, and the adjustment to the axial position includes reciprocally moving the rotor axially to flush fines accumulating in an end bell of the high pressure feeder.

8. The method of claim 5 wherein adjusting the axial position of the pocket rotor includes reciprocally axially moving the rotor.

9. A method to control a rotational speed of a pocket rotor in a chamber of a high pressure feeder comprising:
rotating the pocket rotor;
determining an actual flow rate of a high pressure slurry discharged by the high pressure feeder, wherein the high pressure slurry passes through the rotating pocket rotor;
comparing the determined actual flow rate to a desired flow rate of the high pressure slurry discharged by the high pressure feeder;
adjusting a rotational speed of the rotating pocket rotor until the comparison of the determined actual flow rate and the desired flow rate are within a predefined range.

10. The method of 9 wherein the adjustments to the rotational speed of the rotating pocket rotor are in speed steps of no more than five percent of the actual rotational speed.

11. A high pressure feeder for a slurry comprising:
a housing having a low pressure inlet for the slurry, a high pressure outlet for the slurry, a low pressure outlet for low pressure fluid removed from the slurry in the feeder, a high pressure fluid inlet, and a chamber in fluid communication with each of the inlets and outlets;
a pocketed rotor rotatably positioned in the chamber, wherein said pocketed rotor is movable in the chamber and the movement determines a gap between the pocketed rotor and the chamber;
an actuator moving the pocketed rotor to adjust the gap, and
a computer controller generating commands to the actuator to determine an adjustment to the gap, wherein the controller includes a control algorithm which generates the commands based on an input sensor of an operating condition of the high pressure feeder.

12. The high pressure feeder as in clam 11 wherein the pocketed rotor is a tapered cylindrical rotor and is movable axially in the chamber which includes a tapered cylindrical surface facing the rotor, and the actuator includes a shaft coaxial with the pocketed rotor and the shaft is moved axially based on the generated commands.

13. The high pressure feeder as in claim 12 wherein the actuator further comprises gears which turn to axially move the shaft and said gears are turned based on the generated commands.

14. The high pressure feeder as in claim 11 further comprising a remote computer coupled via the internet to the computer controller, wherein the remote computer communicates information regarding a desired gap to the computer controller which applies the desired gap information to generated the commands.

15. The high pressure feeder as in claim 11 wherein the input sensor includes at least one of a vibration sensor monitoring a vibration of the feeder, an acoustical sensor monitoring sounds emanating from the feeder, a fluid pressure sensor monitoring a fluid pressure in the gap, a power meter monitoring power applied to rotate the pocket rotor, and flow meters measuring a high pressure slurry flow from the high pressure outlet, a high pressure liquid flow into the high pressure inlet, and a low pressure slurry flow into the low pressure inlet.
